(19) United States
(12) Patent Application Publication
(10) Pub. No.: US 2018/0188959 A1
(43) Pub. Date: Jul. 5, 2018

(54) Memory Module With Integrated Training

(71) Applicants: Shachi K. Thakkar, Folsom, CA (US); Richard P. Mangold, Forest Grove, OR (US); Tonia G. Morris, Irmo, SC (US); John V. Lovelace, Irmo, SC (US)

(72) Inventors: Shachi K. Thakkar, Folsom, CA (US); Richard P. Mangold, Forest Grove, OR (US); Tonia G. Morris, Irmo, SC (US); John V. Lovelace, Irmo, SC (US)

(21) Appl. No.: 15/394,341

(22) Filed: Dec. 29, 2016

(51) Int. Cl. G06F 3/06

(52) U.S. Cl. CPC G06F 3/0604; G06F 3/0673; G06F 3/0632

(57) ABSTRACT

An embodiment of a memory module controller may be communicatively coupled to a storage media to initialize training-related register values, train the storage media independent of a BIOS, calibrate a sense amplifier, and indicate when the storage media is completely trained. Other embodiments are disclosed and claimed.

### TECHNICAL FIELD

Embodiments generally relate to memory systems.

### BACKGROUND

In some memory systems, training is performed shortly after powering on the system. Training may include set up and calibration to get the various input/output (IO) interfaces ready to accept commands. For example, higher double data rate (DDR) speeds may require that dynamic random access memory (DRAM) channels be tuned for optimum signal quality and DDR bus timing. This tuning is performed by the basic input/output system (BIOS) during boot up and may be referred to as DDR training. On some systems, for example, a BIOS Memory Reference Code (MRC) may initialize a memory controller and optimize read/write timing and voltage for optimal performance.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a memory apparatus according to an embodiment;

FIGS. 3A to 3D are flowcharts of an example of a method of training a storage media according to an embodiment;

FIG. 4 is a block diagram of an example of a memory module according to an embodiment; and

FIG. 5 is an illustrative flow diagram of an example of a host side operation and a dual inline memory module (DIMM) side operation according to an embodiment.

### DESCRIPTION OF EMBODIMENTS

Various embodiments described herein may include a memory component and/or an interface to a memory component. Such memory components may include volatile and/or nonvolatile memory. Nonvolatile memory may be a storage medium that does not require power to maintain the state of data stored by the medium. Non-limiting examples of nonvolatile memory may include any or a combination of: solid state memory (such as planar or three dimensional (3D) NAND flash memory or NOR flash memory), 3D cross point memory, storage devices that use chalcogenide phase change material (e.g., chalcogenide glass), a byte-addressable three dimensional cross point memory, other byte addressable write-in-place nonvolatile memory devices, such as single or multi-level Phase Change Memory (PCM), ferroelectric memory, silicon-oxide-nitride-oxide-silicon (SONOS) memory, polymer memory (e.g., ferroelectric polymer memory), ferroelectric transistor random access memory (Fe-TRAM),), magnetoresistive random access memory (MRAM) memory that incorporates memristor technology, spin transfer torque (STT)-MRAM, ovonic memory, resistive memory, nanowire memory, electrically erasable programmable read-only memory (EEPROM), other various types of non-volatile random access memories (RAMs), and magnetic storage memory. In some embodiments, 3D cross point memory may comprise a transistor-less stackable cross point architecture in which memory cells sit at the intersection of word lines and bit lines and are individually addressable and in which bit storage is based on a change in bulk resistance. In particular embodiments, a memory component with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at jedec. org).

Volatile memory may be a storage medium that requires power to maintain the state of data stored by the medium. Non-limiting examples of volatile memory may include various types of RAM, such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

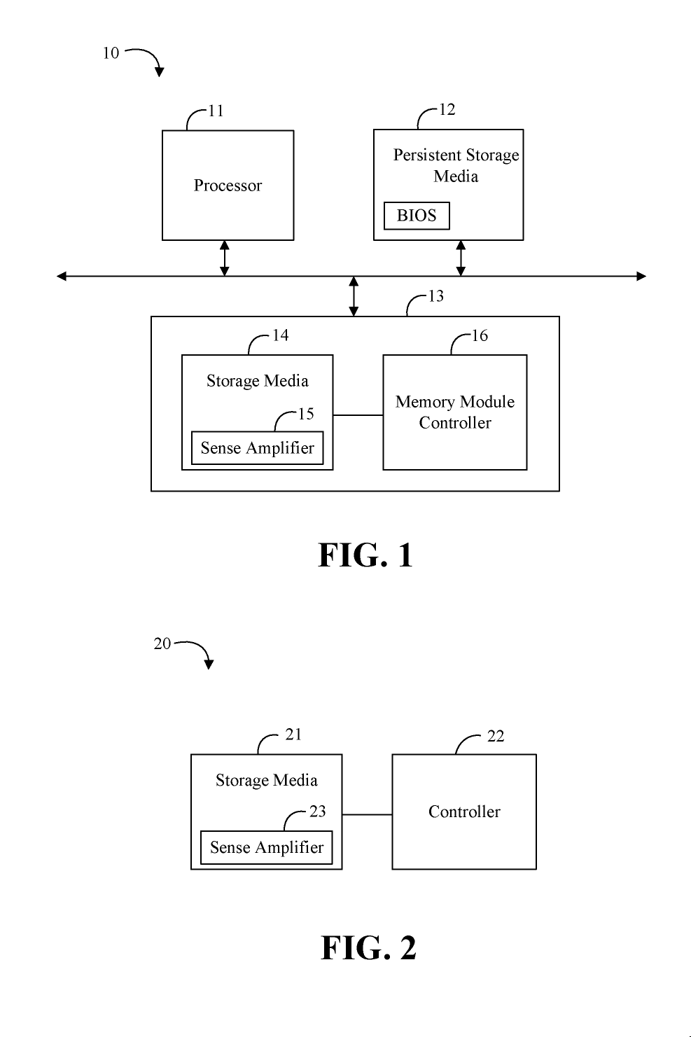

Turning now to FIG. 1, an embodiment of an electronic processing system 10 may include a processor 11, a persistent storage media 12 communicatively coupled to the processor 11 to store a basic input/output system (BIOS), and a memory module 13 communicatively coupled to the processor 11. The memory module 13 may include storage media 14 having a sense amplifier 15, and a memory module controller 16 communicatively coupled to the storage media 14 to initialize training-related register values, train the memory module 13 independent of the BIOS, calibrate the sense amplifier 15, and indicate when the memory module 13 is completely trained. Training for the memory module 10 may involve, for example, two interfaces. One interface may include an interface between the processor 11 and the memory module controller 16. Another interface may involve the interface between the memory module controller 16 and the storage media 14.

In some embodiments of the electronic processing system 10, the memory module controller 16 may be further configured to determine if the memory module 13 was previously trained, train the memory module 13 and save training-related settings if the memory module 13 is determined to not have been previously trained, and retrieve previously saved training-related settings if the memory module 13 is determined to have been previously trained. The memory module controller 16 may also be further configured to determine if the sense amplifier 15 was previously calibrated, calibrate the sense amplifier 15 and save calibration settings if the sense amplifier 15 is determined to not have been previously calibrated, and retrieve previously saved calibration settings if the sense amplifier 15 is determined to have been previously calibrated. For example, the memory module 13 may include a DIMM and the storage media 14 may include one or more memory devices (e.g. DRAM or NVM devices). Non-limiting examples of the electronic processing system 10 include server systems, desktop computers, laptop computers, convertible computers, 2-in-1 computers, all-in-one computers, and tablet computers.

Embodiments of each of the above processor 11, persistent storage media 12, memory module 13, storage media 14, sense amplifier 15, memory module controller 16, and other components of the electronic processing system 10 may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or in fixed-functionality logic hardware using circuit technology such as, for example, application specific integrated circuit (ASIC), complementary metal oxide semiconductor (CMOS) or transistor-transistor logic (TTL) technology, or any combination thereof. Alternatively, or additionally, some operational aspects of these components may be implemented in one or more modules as a set of logic instructions stored in a machine- or computer-readable storage medium such as RAM, read only memory (ROM), programmable ROM (PROM), firmware, flash memory, etc., to be executed by a processor or computing device. For example, computer program code to carry out the operations of the components may be written in any combination of one or more operating system applicable/appropriate programming languages, including an object oriented programming language such as JAVA, SMALLTALK, C++, C# or the like and conventional procedural programming languages, such as the “C” programming language or similar programming languages.

Turning now to FIG. 2, an embodiment of a memory apparatus 20 may include storage media 21, and a controller 22 communicatively coupled to the storage media 21 to train the storage media 21 independent of a basic input output system. For example, the storage media may include a sense amplifier 23 and the controller 22 may be further configured to initialize training-related register values, calibrate the sense amplifier 23, and indicate when the storage media 21 is completely trained. In some embodiments of the memory apparatus 20, the controller 22 may be further configured to determine if the storage media 21 was previously trained, train the storage media 21 and save the training-related settings if the storage media 21 is determined to not have been previously trained, and retrieve previously saved training-related settings if the storage media 21 is determined to have been previously trained.

In some embodiments, the controller 22 may also be further configured to determine if the sense amplifier 23 was previously calibrated, calibrate the sense amplifier 23 and save the calibration settings if the sense amplifier 23 is determined to not have been previously calibrated, and retrieve previously saved calibration settings if the sense amplifier 23 is determined to have been previously calibrated. In any of the embodiments described herein, the storage media 21 may include one or more memory devices. For example, the storage media 21 may include one or more DDR memory devices. In some embodiments, the storage media 21 may include a DIMM and the controller 22 may be located on the DIMM.

Embodiments of each of the above storage media 21, controller 22, sense amplifier 23, and other components of the memory apparatus 20 may be implemented in hardware, software, or any combination thereof. For example, hardware implementations may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, some operational aspects of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more operating system applicable/appropriate programming languages, including an object oriented programming language such as JAVA, SMALLTALK, C++, C# or the like and conventional procedural programming languages, such as the “C” programming language or similar programming languages.

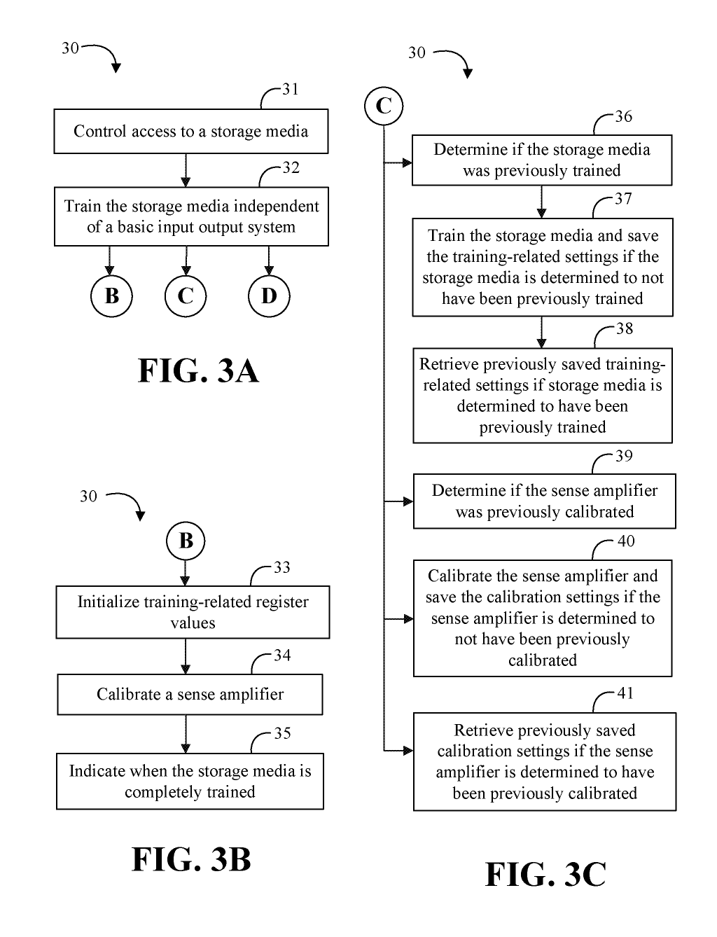

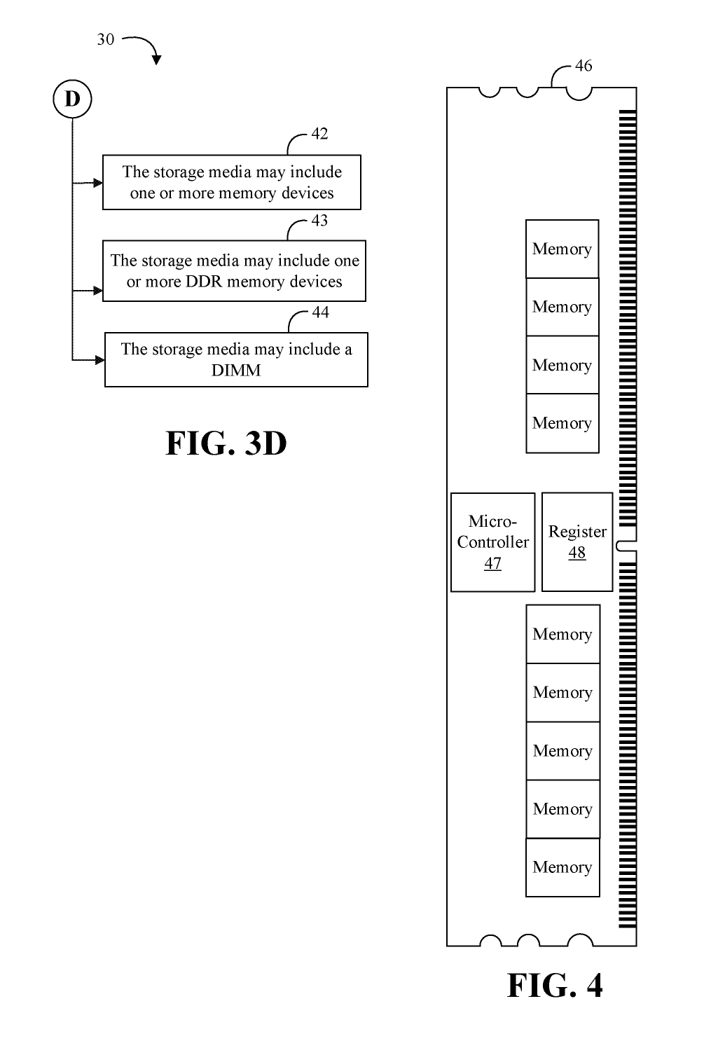

Turning now to FIGS. 3A to 3D, an embodiment of a method 30 of training a storage media may include controlling access to a storage media at block 31, and training the storage media independent of a basic input output system at block 32. For example, the method 30 may further include initializing training-related register values at block 33, calibrating a sense amplifier at block 34, and indicating when the storage media is completely trained at block 35. Some embodiments of the method 30 may further include determining if the storage media was previously trained at block 36, training the storage media and saving the training-related settings if the storage media is determined to not have been previously trained at block 37, and retrieving previously saved training-related settings if storage media is determined to have been previously trained at block 38.

In some embodiments, the method 30 may further include determining if the sense amplifier was previously calibrated at block 39, calibrating the sense amplifier and saving the calibration settings if the sense amplifier is determined to not have been previously calibrated at block 40, and retrieving previously saved calibration settings if the sense amplifier is determined to have been previously calibrated at block 41. The storage media may include one or more memory devices at block 42. For example, the storage media may include one or more DDR memory devices at block 43. In some embodiments, the storage media may include a DIMM at block 44.

Embodiments of the method 30 may be implemented in an electronic processing system or a memory apparatus such as, for example, those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more operating system applicable/appropriate programming languages, including an object oriented programming language such as JAVA, SMALLTALK, C++ or the like and conventional procedural programming languages, such as the “C” programming language or similar programming languages. For example, embodiments of the method 30 may be implemented on a computer readable medium as described in connection with Examples 18 to 24 below.

In some other systems, DDR IO link training may be relatively slow when done by a BIOS. For example, in some DDR3/4 DIMMs the BIOS may be in control of the entire DDR interface training. Advantageously, some embodiments may provide faster DDR IO link training by, for example, offloading the work to a micro-controller.

Turning now to FIG. 4, a memory module 46 may have a DIMM form factor. The DIMM 46 may include one or more memory devices, such as DDR DRAM (or SDRAM) or NVM devices. Other memory components may be placed on an opposite side of the DIMM 46 (not shown) and the DIMM may include other electronic components (not shown). The DIMM 46 may include a micro-controller 47, which may enable the DIMM 46 to be considered a smart DIMM. For example, firmware on the DIMM 46 may enable the micro-controller 47 to handshake with the BIOS. Advantageously, the micro-controller 47 may be further configured to train the DDR IO local to the DIMM 46. Advantageously, the local training with the micro-controller 47 may make the DDR link training much faster because the BIOS does not need to perform the training over a relatively slower system management bus (SMBUS) interface. For example, firmware on the DIMM 46 may include a set of instructions which when executed by the micro-controller 47 cause the micro-controller 47 to initialize and train the DDR IO. For example, the DIMM 46 may include one or more registers 48 (e.g. including training registers to initialize). The micro-controller 47 based initialization and training may be faster, not only at cold boot, but also during a warm reset and other power state flows where boot time may be critical, and the system/platform needs to be initialized and ready within a given platform boot time requirement.

Without being limited to specific operations, training may include adjusting or tuning various operating voltages, frequencies, and/or signal timings to improve or optimize IO on high speed buses. Some training may involve various on-die terminations, read/write leveling (e.g. using a fly-by topology to deliberately introduce flight-time skew, thereby avoiding simultaneous switching noise), Vref tuning, command timing, control timing, equalization settings, and/or address timing.

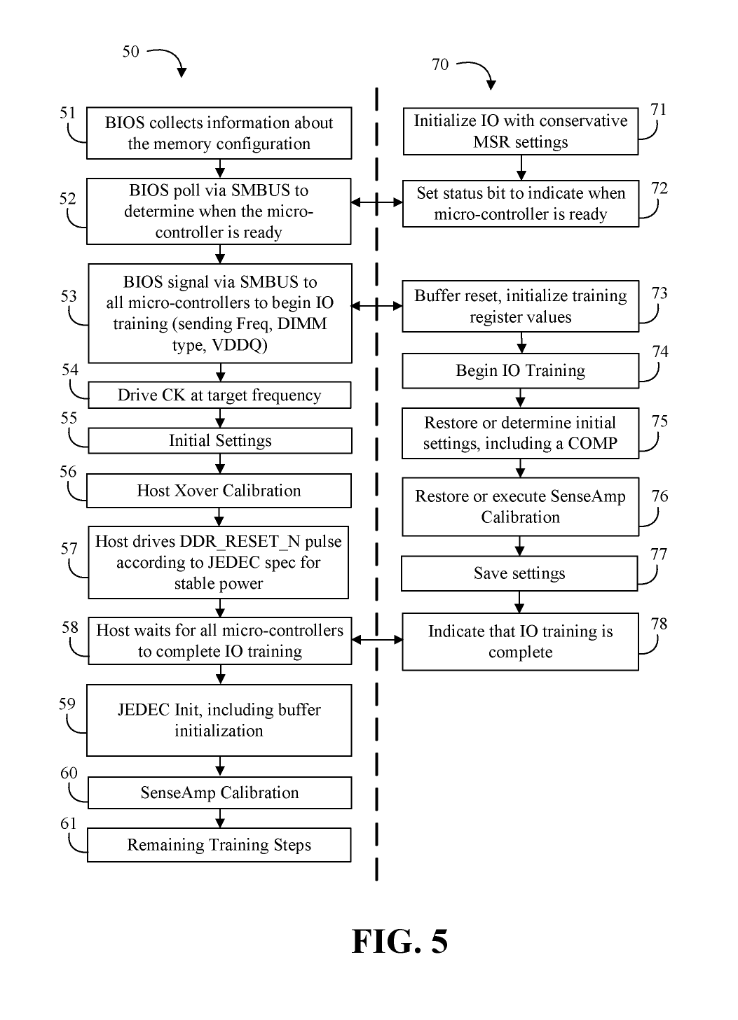

Turning now to FIG. 5, various operations may be split between a host side 50 and a DIMM side 70 in accordance with an embodiment. In general, before the IO circuits may be used, there is an initialization process that may be coordinated between the host BIOS and the micro-controller on the DIMM side 70. As the system first powers on, the host BIOS may collect information about the system memory configuration at block 51 to determine which type of memory technology is in each DIMM slot. With this information, the BIOS may determine an appropriate operating frequency for the bus, and may program the host IO's to function according to a DDR protocol. When the system initially powers on the micro-controller may also initialize the IO on the DIMM at block 71 such that a command interface may function with conservative mode register set (MRS) timings. Once the command bus is stable enough to receive MRS commands with conservative timings, the micro-controller may indicate that it is ready by setting a bit in a boot status register (BSR) at block 72. The BIOS may poll via the SMBUS at block 52 to determine when the micro-controller has completed this process.

Once the BIOS has determined the frequency of DDR operation, the micro-controller can begin programming the default IO settings in the DDR interface for the DIMM operation. The system BIOS may send information to the micro-controller at block 53 to indicate the operating frequency and VDDQ operating voltage based on the system configuration. The host BIOS may also indicate to the micro-controller at block 53 that the IO initialization process should proceed.

Once micro-controller knows the operating frequency and supply voltage, the micro-controller may proceed with initializing all the static settings in the IO at block 73 (e.g. including resetting the buffers, initializing the training register values, etc.). The micro-controller may then begin IO training at block 74 (e.g. for the storage media) and either restore or determine initial settings (e.g. including an IO compensation) at block 75 (e.g. for the memory module). For example, if appropriate training-related settings were previously saved, those settings may be retrieved and applied to the DIMM. The micro-controller may then restore or execute sense amplifier calibration at block 76. For example, if sense amplifier calibration has been previously executed in a previous boot, static values that were saved from that earlier calibration could be set, thus bypassing a subsequent execution of the sense amplifier calibration process. Newly determined training-related settings and/or sense amplifier settings (or adjustments to previously determined values) may be saved at block 77. For example, the DIMM may include NVM to save such settings. Advantageously, saving and restoring prior settings may provide substantial time savings for the training process (e.g. particularly for warm boots). The micro-controller may provide a signal or command at block 78 to indicate to the host that the IO training is complete.

In parallel, the host BIOS may also drive the clock at the target frequency at block 54, initialize the host IO static settings at block 55, and run crossover calibration at block 56. Once the crossover calibration is complete, the host may drive a DDR_RESET_N pulse according to JEDEC specifications for stable power at block 57. The BIOS may then poll the micro-controller via the SMBUS at block 58 to confirm that the micro-controller has completed the training (e.g. initial IO settings and sense amplifier calibration for the DIMMs).

Once the host BIOS receives the confirmation from all DIMM micro-controllers that the training has been completed (e.g. in a multi-DIMM system), the host BIOS may proceed with JEDEC initialization for all the DIMMs in the system at block 59, including initialization of the buffer setting. After JEDEC initialization, the BIOS may execute a host-side sense amplifier calibration at block 60 (e.g. for host side receivers) and then execute the rest of the host training flow at block 61 (e.g. for host side receivers). Advantageously, in some embodiments the use of firmware/micro-controllers on the DIMMs may provide faster initialization of the IO and faster overall boot time.

### ADDITIONAL NOTES AND EXAMPLES

Example 1 may include an electronic processing system, comprising a processor, a persistent storage media communicatively coupled to the processor to store a basic input/output system (BIOS) and a memory module communicatively coupled to the processor, the memory module including storage media having a sense amplifier, and a memory module controller communicatively coupled to the storage media to initialize training-related register values, train the memory module independent of the BIOS, calibrate the sense amplifier, and indicate when the memory module is completely trained.

Example 2 may include the system of Example 1, wherein the memory module controller is further to determine if the memory module was previously trained, train the memory module and save training-related settings if the memory module is determined to not have been previously trained, and retrieve previously saved training-related settings if the memory module is determined to have been previously trained.

Example 3 may include the system of any of Examples 1 to 2, wherein the memory module controller is further to determine if the sense amplifier was previously calibrated, calibrate the sense amplifier and save calibration settings if the sense amplifier is determined to not have been previously calibrated, and retrieve previously saved calibration settings if the sense amplifier is determined to have been previously calibrated.

Example 4 may include a memory apparatus, comprising storage media, and a controller communicatively coupled to the storage media to train the storage media independent of a basic input output system.

Example 5 may include the memory apparatus of Example 4, wherein the storage media includes a sense amplifier, and wherein the controller is further to initialize training-related register values, calibrate a sense amplifier, and indicate when the storage media is completely trained.

Example 6 may include the memory apparatus of Example 5, wherein the controller is further to determine if the storage media was previously trained, train the storage media and save training-related settings if the storage media is determined to not have been previously trained, and retrieve previously saved training-related settings if the storage media is determined to have been previously trained.

Example 7 may include the memory apparatus of Example 5, wherein the controller is further to determine if the sense amplifier was previously calibrated, calibrate the sense amplifier and save calibration settings if the sense amplifier is determined to not have been previously calibrated, and retrieve previously saved calibration settings if the sense amplifier is determined to have been previously calibrated.

Example 8 may include the memory apparatus of any of Examples 4 to 7, wherein the storage media comprises one or more memory devices.

Example 9 may include the memory apparatus of any of Examples 4 to 7, wherein the storage media comprises one or more double data rate memory devices.

Example 10 may include the memory apparatus of any of Examples 4 to 7, wherein the storage media comprises a dual inline memory module (DIMM) and wherein the controller is located on the DIMM.

Example 11 may include a method of training a storage media, comprising controlling access to a storage media, and training the storage media independent of a basic input output system.

Example 12 may include the method of Example 11, further comprising initializing training-related register values, calibrating a sense amplifier, and indicating when the storage media is completely trained.

Example 13 may include the method of Example 12, further comprising determining if the storage media was previously trained, training the storage media and saving training-related settings if the storage media is determined to not have been previously trained, and retrieving previously saved training-related settings if storage media is determined to have been previously trained.

Example 14 may include the method of Example 12, further comprising determining if the sense amplifier was previously calibrated, calibrating the sense amplifier and saving calibration settings if the sense amplifier is determined to not have been previously calibrated, and retrieving previously saved calibration settings if the sense amplifier is determined to have been previously calibrated.

Example 15 may include the method of any of Examples 11 to 14, wherein the storage media comprises one or more memory devices.

Example 16 may include the method of any of Examples 11 to 14, wherein the storage media comprises one or more double data rate memory devices.

Example 17 may include the method of any of Examples 11 to 14, wherein the storage media comprises a dual inline memory module (DIMM).

Example 18 may include at least one computer readable medium, comprising a set of instructions, which when executed by a computing device, cause the computing device to control access to a storage media, and train the storage media independent of a basic input output system.

Example 19 may include the at least one computer readable medium of Example 18, comprising a further set of instructions, which when executed by a computing device, cause the computing device to initialize training-related register values, calibrate a sense amplifier, and indicate when the storage media is completely trained.

Example 20 may include the at least one computer readable medium of Example 19, comprising a further set of instructions, which when executed by a computing device, cause the computing device to determine if the storage media was previously trained, train the storage media and save training-related settings if the storage media is determined to not have been previously trained, and retrieve previously saved training-related settings if storage media is determined to have been previously trained.

Example 21 may include the at least one computer readable medium of Example 19, comprising a further set of instructions, which when executed by a computing device, cause the computing device to determine if the sense amplifier was previously calibrated, calibrate the sense amplifier and save calibration settings if the sense amplifier is determined to not have been previously calibrated, and retrieve previously saved calibration settings if the sense amplifier is determined to have been previously calibrated.

Example 22 may include the at least one computer readable medium of any of Examples 18 to 21, wherein the storage media comprises one or more memory devices.

Example 23 may include the at least one computer readable medium of any of Examples 18 to 21, wherein the storage media comprises one or more double data rate memory devices.

Example 24 may include the at least one computer readable medium of any of Examples 18 to 21, wherein the storage media comprises a dual inline memory module (DIM M).

Example 25 may include a memory apparatus, comprising means for controlling access to a storage media, and training the storage media independent of a basic input output system.

Example 26 may include the memory apparatus of Example 25, further comprising means for initializing training-related register values, means for calibrating a sense amplifier, and means for indicating when the storage media is completely trained.

Example 27 may include the memory apparatus of Example 26, further comprising means for determining if the storage media was previously trained, means for training the storage media and saving training-related settings if the storage media is determined to not have been previously trained, and means for retrieving previously saved training-related settings if storage media is determined to have been previously trained.

Example 28 may include the memory apparatus of Example 26, further comprising means for determining if the sense amplifier was previously calibrated, means for calibrating the sense amplifier and saving calibration settings if the sense amplifier is determined to not have been previously calibrated, and means for retrieving previously saved calibration settings if the sense amplifier is determined to have been previously calibrated.

Example 29 may include the memory apparatus of any of Examples 25 to 28, wherein the storage media comprises one or more memory devices.

Example 30 may include the memory apparatus of any of Examples 25 to 28, wherein the storage media comprises one or more double data rate memory devices.

Example 31 may include the memory apparatus of any of Examples 25 to 28, wherein the storage media comprises a dual inline memory module (DIMM).

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system, comprising:
a processor;
a persistent storage media communicatively coupled to the processor to store a basic input/output system (BIOS); and
a memory module communicatively coupled to the processor, the memory module including:
storage media having a sense amplifier; and
a memory module controller communicatively coupled to the storage media to:
initialize training-related register values,
train the memory module independent of the BIOS,
calibrate the sense amplifier, and
indicate when the memory module is completely trained.

2. The system of claim 1, wherein the memory module controller is further to:
determine if the memory module was previously trained;
train the memory module and save training-related settings if the memory module is determined to not have been previously trained; and
retrieve previously saved training-related settings if the memory module is determined to have been previously trained.

3. The system of claim 2, wherein the memory module controller is further to:
determine if the sense amplifier was previously calibrated;
calibrate the sense amplifier and save calibration settings if the sense amplifier is determined to not have been previously calibrated; and
retrieve previously saved calibration settings if the sense amplifier is determined to have been previously calibrated.

4. A memory apparatus, comprising:
storage media; and
a controller communicatively coupled to the storage media to train the storage media independent of a basic input output system.

5. The memory apparatus of claim 4, wherein the storage media includes a sense amplifier, and wherein the controller is further to:
initialize training-related register values;
calibrate a sense amplifier; and
indicate when the storage media is completely trained.

6. The memory apparatus of claim 5, wherein the controller is further to:
determine if the storage media was previously trained;
train the storage media and save training-related settings if the storage media is determined to not have been previously trained; and
retrieve previously saved training-related settings if the storage media is determined to have been previously trained.

7. The memory apparatus of claim 5, wherein the controller is further to:
determine if the sense amplifier was previously calibrated;
calibrate the sense amplifier and save calibration settings if the sense amplifier is determined to not have been previously calibrated; and
retrieve previously saved calibration settings if the sense amplifier is determined to have been previously calibrated.

8. The memory apparatus of claim 4, wherein the storage media comprises:
one or more memory devices.

9. The memory apparatus of claim 4, wherein the storage media comprises:
one or more double data rate memory devices.

10. The memory apparatus of claim 4, wherein the storage media comprises a dual inline memory module (DIMM) and wherein the controller is located on the DIMM.

11. A method of training a storage media, comprising:
controlling access to a storage media; and
training the storage media independent of a basic input output system.

12. The method of claim 11, further comprising:
initializing training-related register values;
calibrating a sense amplifier; and
indicating when the storage media is completely trained.

13. The method of claim 12, further comprising:
determining if the storage media was previously trained;
training the storage media and saving training-related settings if the storage media is determined to not have been previously trained; and
retrieving previously saved training-related settings if storage media is determined to have been previously trained.

14. The method of claim 12, further comprising:
determining if the sense amplifier was previously calibrated;
calibrating the sense amplifier and saving calibration settings if the sense amplifier is determined to not have been previously calibrated; and
retrieving previously saved calibration settings if the sense amplifier is determined to have been previously calibrated.

15. The method of claim 11, wherein the storage media comprises:
one or more memory devices.

16. The method of claim 11, wherein the storage media comprises:
one or more double data rate memory devices.

17. The method of claim 11, wherein the storage media comprises:
a dual inline memory module (DIMM).

18. At least one computer readable medium, comprising a set of instructions, which when executed by a computing device, cause the computing device to:
control access to a storage media; and
train the storage media independent of a basic input output system.

19. The at least one computer readable medium of claim 18, comprising a further set of instructions, which when executed by a computing device, cause the computing device to:
initialize training-related register values;
calibrate a sense amplifier; and
indicate when the storage media is completely trained.

20. The at least one computer readable medium of claim 19, comprising a further set of instructions, which when executed by a computing device, cause the computing device to:
determine if the storage media was previously trained;
train the storage media and save training-related settings if the storage media is determined to not have been previously trained; and
retrieve previously saved training-related settings if storage media is determined to have been previously trained.

21. The at least one computer readable medium of claim 19, comprising a further set of instructions, which when executed by a computing device, cause the computing device to:
determine if the sense amplifier was previously calibrated;
calibrate the sense amplifier and save calibration settings if the sense amplifier is determined to not have been previously calibrated; and
retrieve previously saved calibration settings if the sense amplifier is determined to have been previously calibrated.

22. The at least one computer readable medium of claim 18, wherein the storage media comprises:
one or more memory devices.

23. The at least one computer readable medium of claim 18, wherein the storage media comprises:
one or more double data rate memory devices.

24. The at least one computer readable medium of claim 18, wherein the storage media comprises:
a dual inline memory module (DIMM).
